(19) United States
(12) Patent Application Publication
(10) Pub. No.: US 2026/0024934 A1
(43) Pub. Date: Jan. 22, 2026

(54) Connector and Connector Assembly

(71) Applicant: Tyco Electronics (Shanghai) Co., Ltd., Shanghai (CN)

(72) Inventors: Xiaobing Li, Shanghai (CN); Guixin (Wesley) Wu, Shanghai (CN)

(73) Assignee: Tyco Electronics (Shanghai) Co., Ltd., Shanghai (CN)

(21) Appl. No.: 19/272,661

(22) Filed: Jul. 17, 2025

(30) Foreign Application Priority Data
Jul. 17, 2024 (CN) 202410963701.9

(51) Int. Cl. H01R 12/91; H01R 12/70; H01R 12/71; H01R 13/17; H01R 13/405; H01R 13/502

(52) U.S. Cl. CPC H01R 12/91; H01R 12/707; H01R 12/716; H01R 13/17; H01R 13/405; H01R 13/502

(57) ABSTRACT

The connector includes an outer housing having walls. The connector further includes an inner housing arranged in the outer housing and having mounting slots formed on both sides of the inner housing. The connector further includes two rows of first terminals arranged on two sides of the inner housing. The connector further includes two pairs of second terminals, each first terminal includes a first fixing portion, a first contact arm, and a first elastic structure. The connector further includes two pairs of second terminals having a second fixing portion, a second contact arm, and a second elastic structure.

### CROSS-REFERENCE TO RELATED APPLICATIONS

This application claims the benefit of Chinese Patent Application No. CN 202410963701.9 filed on Jul. 17, 2024 in the State Intellectual Property Office of China, the whole disclosure of which is incorporated herein by reference.

### FIELD OF THE INVENTION

The present invention pertains to a connector, and a connector assembly including the connector.

### BACKGROUND

A connector having a floating function typically includes an outer housing, an inner housing, first terminals, and second terminals. In the prior art, the first terminals and the second terminals are respectively arranged on two sides of the inner housing in a transverse direction thereof. Each first terminal is provided with a first fixing portion fixed to the outer housing, a first contact arm embedded into a mounting slot of the inner housing, and a first elastic structure connected between the first fixing portion and the first contact arm. Each second terminal is provided with a second fixing portion fixed to the outer housing, a second contact arm embedded in a mounting slot of the inner housing, and a second elastic structure connected between the second fixing portion and the second contact arm. In the prior art, both the first elastic structures of the first terminals and the second elastic structures of the second terminals extend in the transverse and height directions, so that the second terminals occupy a large transverse space, and thus the overall space occupied by the connector is large, which limits the application of the connector.

### SUMMARY

The connector includes an outer housing having two side walls opposite each other in a transverse direction thereof and two end walls opposite each other in a longitudinal direction thereof. The connector further includes an inner housing arranged in the outer housing and having a plurality of mounting slots formed on both sides of the inner housing in the transverse direction. The connector further includes two rows of first terminals respectively arranged on two sides of the inner housing in the transverse direction. The connector further includes two pairs of second terminals respectively arranged at two ends of the inner housing in the longitudinal direction, each first terminal includes a first fixing portion fixed into a side wall of the outer housing, a first contact arm embedded in a mounting slot of the inner housing, and a first elastic structure connected between the first fixing portion and the first contact arm. The connector further includes the two pairs of second terminals each include a second fixing portion fixed into an end wall of the outer housing, a second contact arm embedded in the mounting slot of the inner housing, and a second elastic structure connected between the second fixing portion and the second contact arm. The connector further includes the first elastic structure is elastically deformable in the transverse direction, and the second elastic structure is elastically deformable in the longitudinal direction, the inner housing is floatable in the transverse direction and in the longitudinal direction relative to the outer housing, the second elastic structure is located between adjacent end walls of the outer housing and the inner housing, and extends in a height direction of the outer housing and in an inclination direction at a predetermined angle relative to the longitudinal direction, the second elastic structure is elastically deformable in the longitudinal direction and in the transverse direction.

### BRIEF DESCRIPTION OF DRAWINGS

In the following, the present invention is described in more detail with references to the drawings in which:

FIG. 1 shows an illustrative perspective view of a connector according to an exemplary embodiment of the present invention;

FIG. 2 shows a longitudinal section of the connector according to an exemplary embodiment of the present invention;

FIG. 3 shows a transverse section of the connector according to an exemplary embodiment of the present invention;

FIG. 4 shows an illustrative view of assembly of an inner housing, first terminals and second terminals of the connector according to an exemplary embodiment of the present invention;

FIG. 5 shows an illustrative perspective view of the inner housing, the first terminals and the second terminals of the connector according to an exemplary embodiment of the present invention, with one of the second terminals having not yet been mounted to the inner housing;

FIG. 6 shows an illustrative perspective view of the first terminals and the second terminals of the connector according to an exemplary embodiment of the present invention;

FIG. 7 shows an illustrative perspective view of a connector according to another exemplary embodiment of the present invention;

FIG. 8 shows a longitudinal section of the connector according to another exemplary embodiment of the present invention;

FIG. 9 shows a transverse section of the connector according to another exemplary embodiment of the present invention;

FIG. 10 shows an illustrative view of assembly of an inner housing, first terminals and second terminals of the connector according to another exemplary embodiment of the present invention;

FIG. 11 shows an illustrative perspective view of the inner housing, the first terminals and the second terminals of the connector according to another exemplary embodiment of the present invention, with one of the second terminals having not yet been mounted to the inner housing; and

FIG. 12 shows an illustrative perspective view of the first terminals and the second terminals of the connector according to another exemplary embodiment of the present invention.

### DETAILED DESCRIPTION OF THE EMBODIMENTS

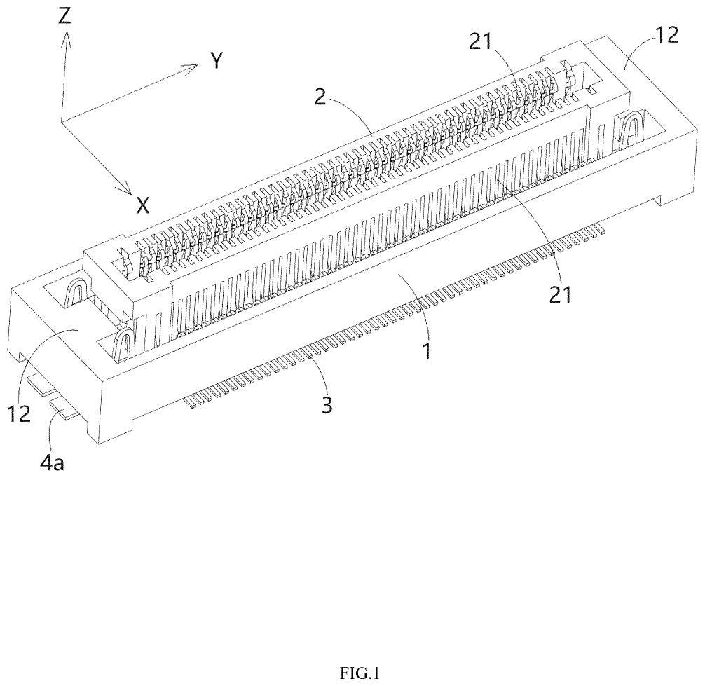

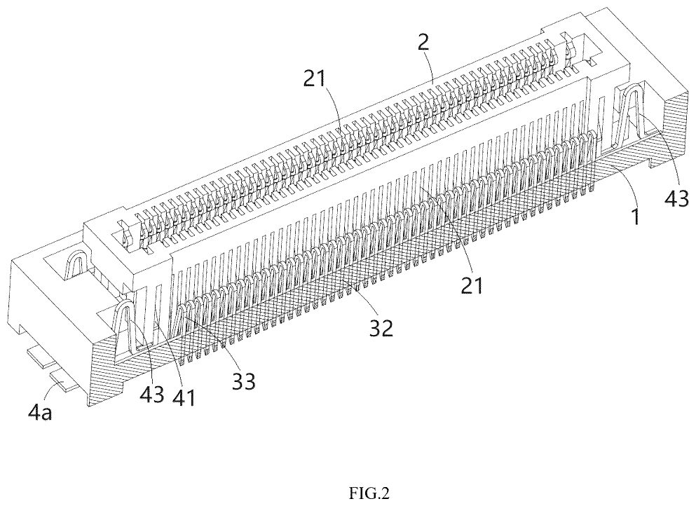

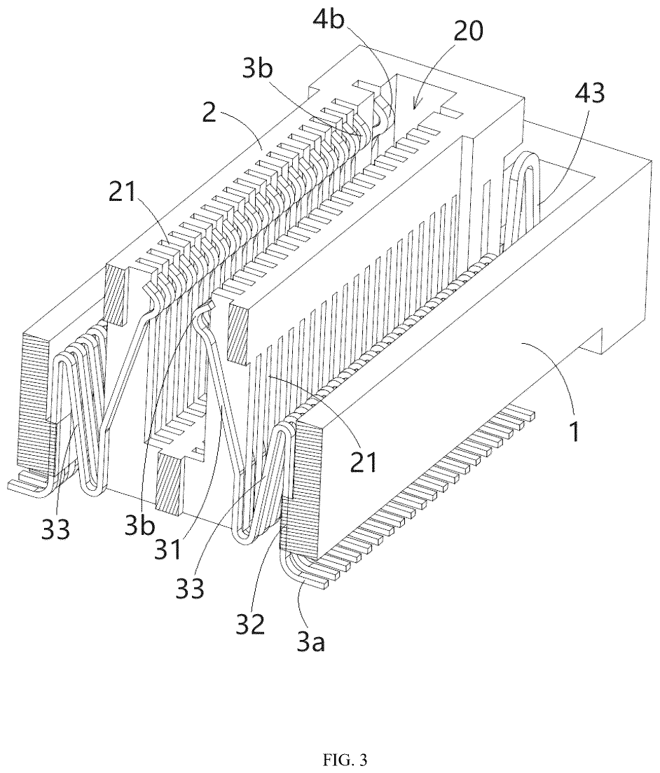

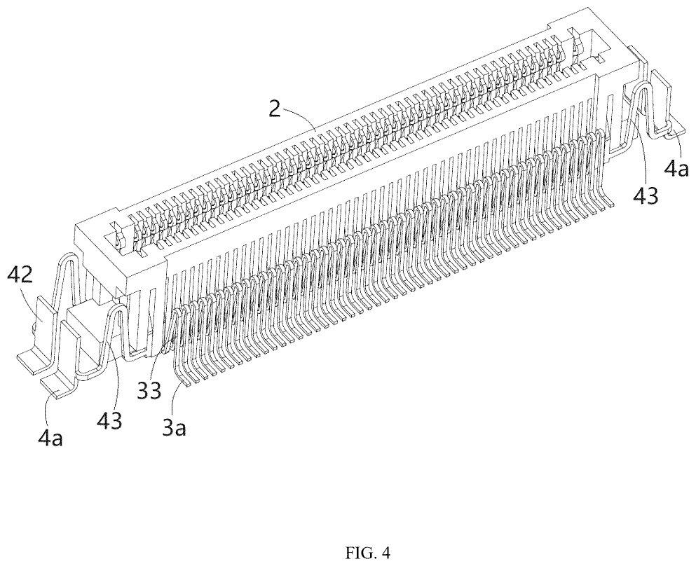

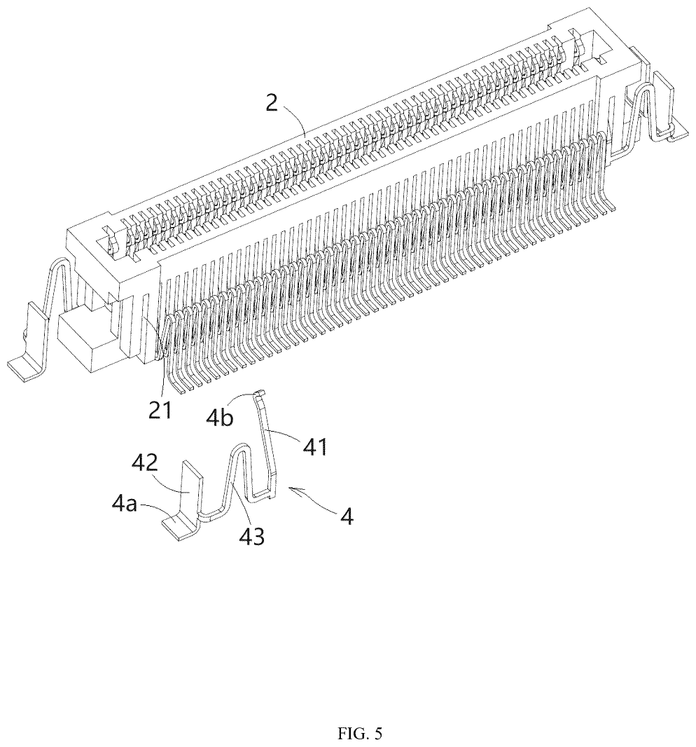

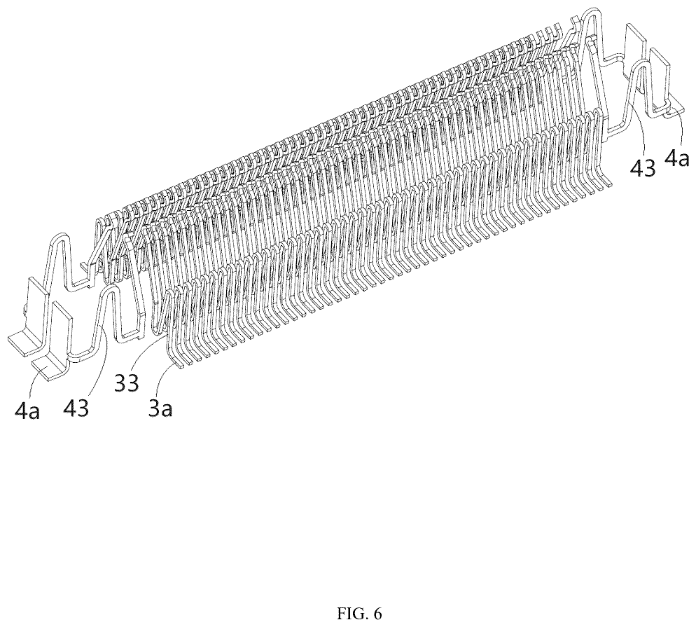

As shown in FIGS. 1 to 6, in an exemplary embodiment of the present invention, a connector is disclosed. The connector includes: an outer housing 1, an inner housing 2, two rows of first terminals 3 and two pairs of second terminals 4. The outer housing 1 has two side walls 11 opposite each other in a transverse direction X thereof and two end walls 12 opposite each other in a longitudinal direction Y thereof. The inner housing 2 is arranged in the outer housing 1 and has a plurality of mounting slots 21 formed on both sides thereof in the transverse direction X. The two rows of first terminals 3 are respectively arranged on two sides of the inner housing 2 in the transverse direction X. The two pairs of second terminals 4 is respectively arranged at two ends of the inner housing 2 in the longitudinal direction Y.

As shown in FIGS. 1 to 6, in the illustrated embodiment, the first terminals 3 each include a first fixing portion 32 fixed into the side wall 11 of the outer housing 1, a first contact arm 31 embedded in the mounting slot 21 of the inner housing 2, and a first elastic structure 33 connected between the first fixing portion 32 and the first contact arm 31.

As shown in FIGS. 1 to 6, in the illustrated embodiment, the second terminals 4 each include a second fixing portion 42 fixed into the end wall 12 of the outer housing 1, a second contact arm 41 embedded in the mounting slot 21 of the inner housing 2, and a second elastic structure 43 connected between the second fixing portion 42 and the second contact arm 41.

As shown in FIGS. 1 to 6, in the illustrated embodiment, the first elastic structure 33 is elastically deformable in the transverse direction X, and the second elastic structure 43 is elastically deformable in the longitudinal direction Y, so that the inner housing 2 is floatable in the transverse direction X and in the longitudinal direction Y relative to the outer housing 1.

As shown in FIGS. 1 to 6, in the illustrated embodiment, the first elastic structure 33 is located between adjacent side walls of the outer housing 1 and the inner housing 2 and extends in the transverse direction X and in the height direction Z of the outer housing 1, so that the first elastic structure 33 is elastically deformable in the transverse direction X.

As shown in FIGS. 1 to 6, in the illustrated embodiment, the first elastic structure 33 is bent into one of a U shape, an N shape or an Ω shape, and has two ends thereof respectively connected to the first fixing portion 32 and the first contact arm 31.

As shown in FIGS. 1 to 6, in the illustrated embodiment, the second elastic structure 43 is located between adjacent side walls of the outer housing 1 and the inner housing 2 and extends in the longitudinal direction Y and in the height direction Z of the outer housing 1, so that the second elastic structure 43 is elastically deformable in the longitudinal direction Y.

As shown in FIGS. 1 to 6, in the illustrated embodiment, the second elastic structure 43 is bent into one of a U shape, an N shape or an Ω shape, and has two ends thereof respectively connected to the second fixing portion 42 and the second contact arm 41.

As shown in FIGS. 1 to 6, in the illustrated embodiment, the first terminal 3 further includes a first solder pin 3a connected to a lower end of the first fixing portion 32, and the first solder pin 3a of each row of first terminals 3 being aligned in a line along the longitudinal direction Y. The second terminal 4 further includes a second solder pin 4a connected to a lower end of the second fixing portion 42 and the second solder pin 4a of each pair of second terminals 4 being aligned in a column along the transverse direction X. When viewed along the longitudinal direction Y, two columns of the second solder pins 4a are located between two rows of the first solder pins 3a.

As shown in FIGS. 1 to 6, in the illustrated embodiment, the second fixing portion 42 is plate-shaped and perpendicular to the longitudinal direction Y, and the second solder pin 4a is plate-shaped and perpendicular to the height direction Z, so that the second fixing portion 42 and the second solder pin 4a of the second terminal 4 form an L-shaped plate.

As shown in FIGS. 1 to 6, in the illustrated embodiment, a bottom surface of the first solder pin 3a and a bottom surface of the second solder pin 4a are located in one horizontal plane that is perpendicular to the height direction Z, so as to enable the first solder pin 3a and the second solder pin 4a to be soldered to a circuit board in a surface-mount manner.

As shown in FIGS. 1 to 6, in the illustrated embodiment, an insertion slot 20 extending in the longitudinal direction Y is formed in the inner housing 2, the mounting slots 21 are in communication with the insertion slot 20, the first contact arm 31 is provided with a protruding first contact portion 3b, and the second contact arm 41 is provided with a protruding second contact portion 4b. First contact portions 3b of the two rows of first terminals 3 and second contact portions 4b of the two pairs of second terminals 4 respectively protrude from the mounting slots 21 on the two sides of the inner housing 2 into the insertion slot 20 to make electrical contact with both sides of a mating connector inserted into the insertion slot 20.

As shown in FIGS. 1 to 6, in the illustrated embodiment, first contact arms 31 of one of the rows of first terminals 3 and second contact arms 41 of two of the second terminals 4 are aligned in a line in the longitudinal direction Y and are respectively embedded in the plurality of mounting slots 21 on one side of the inner housing 2. First contact arms 31 of the other row of first terminals 3 and second contact arms 41 of the other two second terminals 4 are aligned in a line in the longitudinal direction Y and are respectively embedded in the plurality of mounting slots 21 on the other side of the inner housing 2.

As shown in FIGS. 1 to 6, in the illustrated embodiment, a top portion of the inner housing 2 protrudes from a top opening of the outer housing 1 to a predetermined height, and the insertion slot 20 is formed in a top surface of the inner housing 2 and extends in the height direction Z of the outer housing 1 to a predetermined depth.

As shown in FIGS. 1 to 6, in the illustrated embodiment, the inner housing 2 is supported in a suspended manner in an inner cavity of the outer housing 1 by means of the first elastic structures 33 of the two rows of first terminals 3 and the second elastic structures 43 of the two pairs of second terminals 4, so that the inner housing 2 is floatable in the transverse direction X, in the longitudinal direction Y and in the height direction Z perpendicular to the transverse direction X and longitudinal direction Y relative to the outer housing 1.

As shown in FIGS. 1 to 6, in the illustrated embodiment, a bottom surface of the inner housing 2 is higher than a bottom surface of the outer housing 1 to allow the inner housing to float in the height direction relative to the outer housing.

As shown in FIGS. 1 to 6, in the illustrated embodiment, the outer housing 1 is an overmolded part formed by overmolding on the two rows of first terminals 3 and the two pairs of second terminals 4, so that the outer housing 1, the two rows of first terminals 3 and the two pairs of second terminals 4 form an integral part.

According to another aspect of the present invention, there is provided a connector assembly. The connector includes: the illustrative connector and a mating connector. The mating connector is configured to mate with the connector.

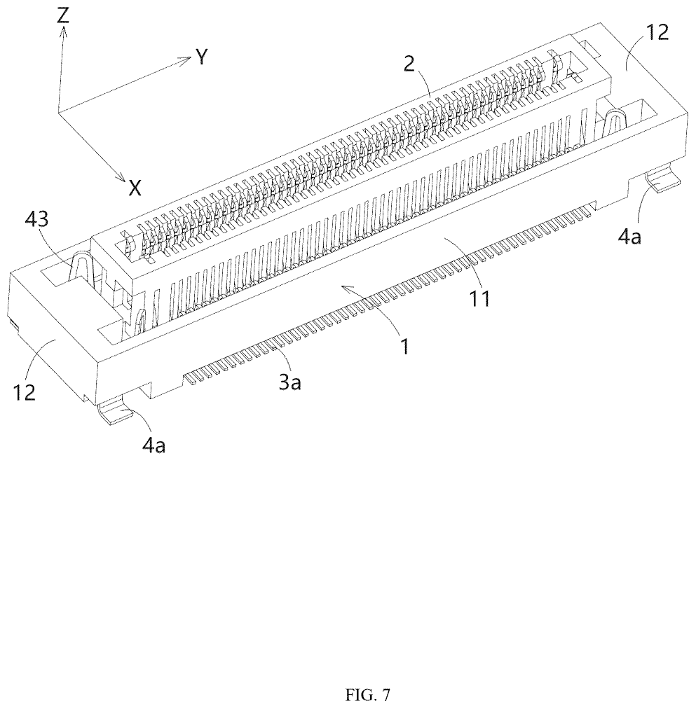

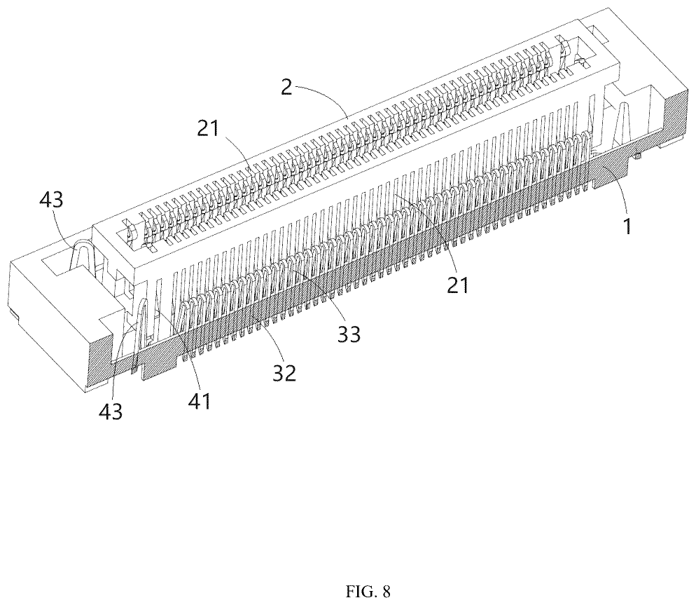

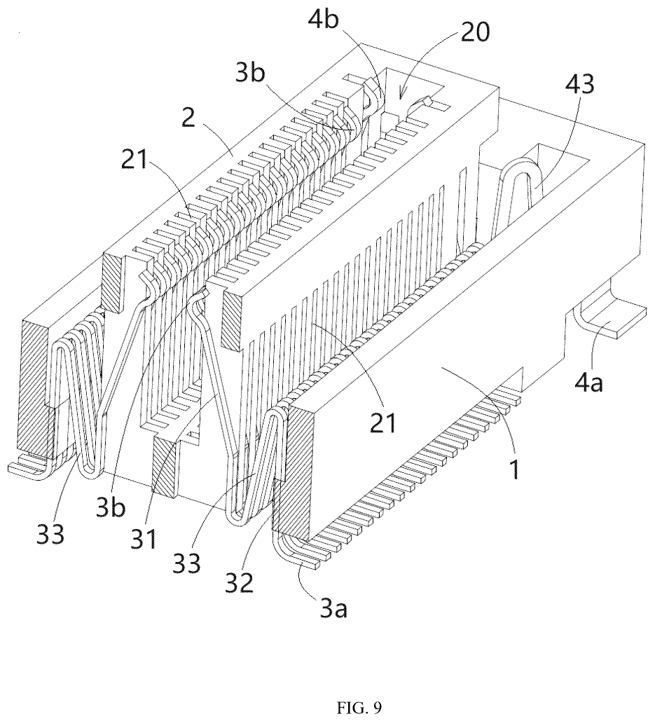

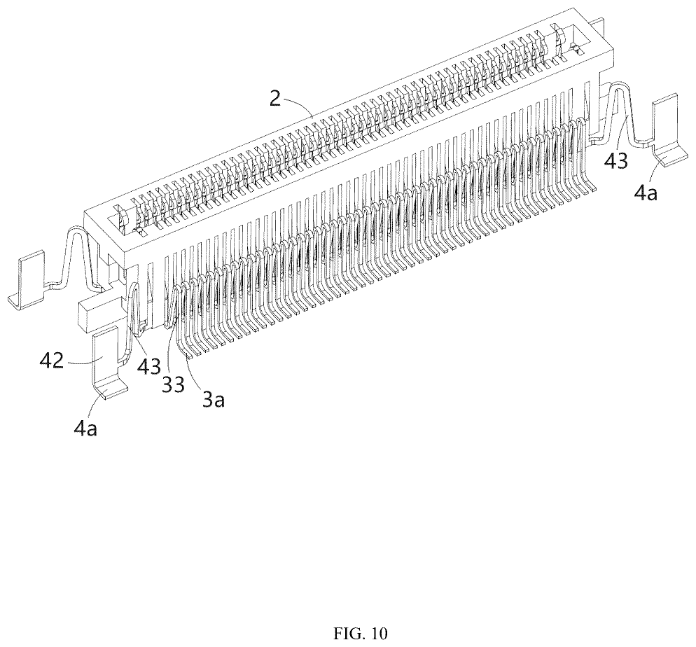

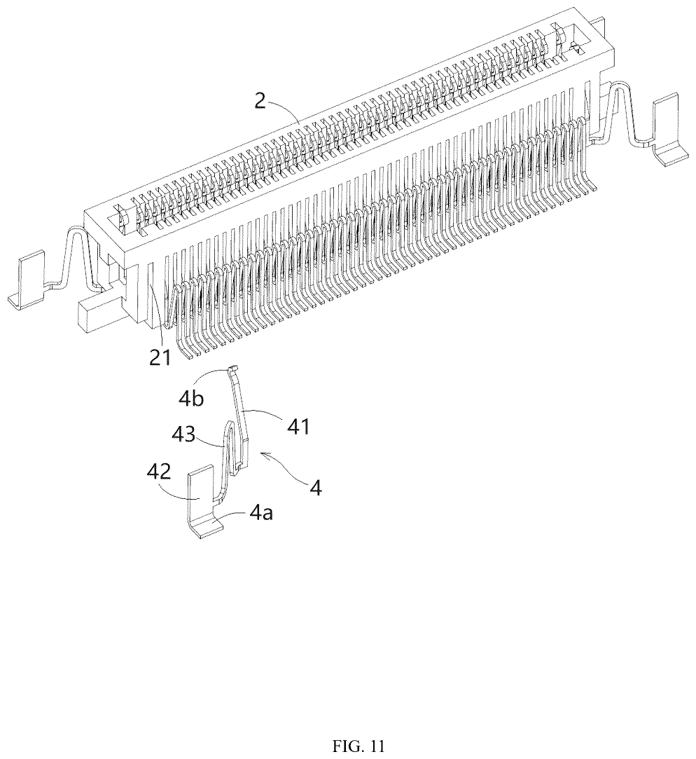

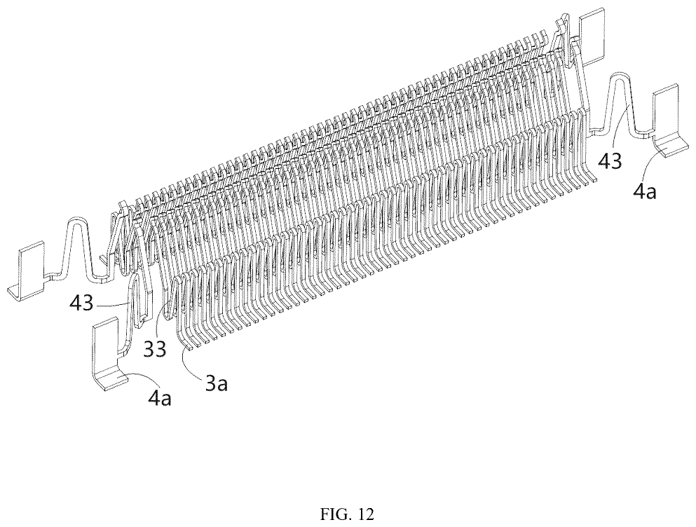

Second embodiment, FIGS. 7 to 12 show the second embodiment according to the present invention. FIG. 7 shows an illustrative perspective view of a connector according to another exemplary embodiment of the present invention; FIG. 8 shows a longitudinal section of the connector according to another exemplary embodiment of the present invention; FIG. 9 shows a transverse section of the connector according to another exemplary embodiment of the present invention; FIG. 10 shows an illustrative view of assembly of an inner housing 2, first terminals 3 and second terminals 4 of the connector according to another exemplary embodiment of the present invention; FIG. 11 shows an illustrative perspective view of the inner housing 2, the first terminals 3 and the second terminals 4 of the connector according to another exemplary embodiment of the present invention, with one of the second terminals 4 having not yet been mounted to the inner housing 2; FIG. 12 shows an illustrative perspective view of the first terminals 3 and the second terminals 4 of the connector according to another exemplary embodiment of the present invention.

As shown in FIGS. 7 to 12, in an exemplary embodiment of the present invention, a connector is disclosed. The connector includes: an outer housing 1, an inner housing 2, two rows of first terminals 3 and two pairs of second terminals 4. The outer housing 1 has two side walls 11 opposite each other in a transverse direction X thereof and two end walls 12 opposite each other in a longitudinal direction Y thereof. The inner housing 2 is arranged in the outer housing 1 and has a plurality of mounting slots 21 formed on both sides thereof in the transverse direction X; The two rows of first terminals 3 are respectively arranged on two sides of the inner housing 2 in the transverse direction X. The two pairs of second terminals 4 is respectively arranged at two ends of the inner housing 2 in the longitudinal direction Y.

As shown in FIGS. 7 to 12, in the illustrated embodiment, the first terminals 3 each include a first fixing portion 32 fixed into the side wall 11 of the outer housing 1, a first contact arm 31 embedded in the mounting slot 21 of the inner housing 2, and a first elastic structure 33 connected between the first fixing portion 32 and the first contact arm 31.

As shown in FIGS. 7 to 12, in the illustrated embodiment, the second terminals 4 each include a second fixing portion 42 fixed into the end wall 12 of the outer housing 1, a second contact arm 41 embedded in the mounting slot 21 of the inner housing 2, and a second elastic structure 43 connected between the second fixing portion 42 and the second contact arm 41.

As shown in FIGS. 7 to 12, in the illustrated embodiment, the first elastic structure 33 is elastically deformable in the transverse direction X, and the second elastic structure 43 is elastically deformable in the longitudinal direction Y, so that the inner housing 2 is floatable in the transverse direction X and in the longitudinal direction Y relative to the outer housing 1.

As shown in FIGS. 7 to 12, in the illustrated embodiment, the first elastic structure 33 is located between adjacent side walls of the outer housing 1 and the inner housing 2 and extends in the transverse direction X and in the height direction Z of the outer housing 1, so that the first elastic structure 33 is elastically deformable in the transverse direction X.

As shown in FIGS. 7 to 12, in the illustrated embodiment, the first elastic structure 33 is bent into one of a U shape, an N shape or an Ω shape, and has two ends thereof respectively connected to the first fixing portion 32 and the first contact arm 31.

As shown in FIGS. 7 to 12, in the illustrated embodiment, the second elastic structure 43 is located between adjacent end walls of the outer housing 1 and the inner housing 2, and extends in a height direction Z of the outer housing 1 and in an inclination direction at a predetermined angle relative to the longitudinal direction Y, so that the second elastic structure 43 is elastically deformable in the longitudinal direction Y and in the transverse direction X

As shown in FIGS. 7 to 12, in the illustrated embodiment, the second elastic structure 43 is bent into one of a U shape, an N shape or an Ω shape, and has two ends thereof respectively connected to the second fixing portion 42 and the second contact arm 41.

As shown in FIGS. 7 to 12, in the illustrated embodiment, the first terminal 3 further includes a first solder pin 3a connected to a lower end of the first fixing portion 32, and the second terminal 4 further includes a second solder pin 4a connected to a lower end of the second fixing portion 42. First solder pins 3a of one of the rows of first terminals 3 and second solder pins 4a of the two of the second terminals 4 are aligned in a line in the longitudinal direction Y, and first solder pins 3a of the other row of first terminals 3 and second solder pins 4a of the other two second terminals 4 are aligned in a line in the longitudinal direction Y.

As shown in FIGS. 7 to 12, in the illustrated embodiment, the second fixing portion 42 is plate-shaped and perpendicular to the transverse direction X, and the second solder pin 4a is plate-shaped and perpendicular to the height direction Z, so that the second fixing portion 42 and the second solder pin 4a of the second terminal 4 form an L-shaped plate.

As shown in FIGS. 7 to 12, in the illustrated embodiment, a bottom surface of the first solder pin 3a and a bottom surface of the second solder pin 4a are located in one horizontal plane that is perpendicular to the height direction Z, so as to enable the first solder pin 3a and the second solder pin 4a to be soldered to a circuit board in a surface-mount manner.

As shown in FIGS. 7 to 12, in the illustrated embodiment, an insertion slot 20 extending in the longitudinal direction Y is formed in the inner housing 2, the mounting slots 21 are in communication with the insertion slot 20, the first contact arm 31 is provided with a protruding first contact portion 3b, and the second contact arm 41 is provided with a protruding second contact portion 4b. First contact portions 3b of the two rows of first terminals 3 and second contact portions 4b of the two pairs of second terminals 4 respectively protrude from the mounting slots 21 on the two sides of the inner housing 2 into the insertion slot 20 to make electrical contact with both sides of a mating connector inserted into the insertion slot 20.

As shown in FIGS. 7 to 12, in the illustrated embodiment, first contact arms 31 of one of the rows of first terminals 3 and second contact arms 41 of two of the second terminals 4 are aligned in a line in the longitudinal direction Y and are respectively embedded in the plurality of mounting slots 21 on one side of the inner housing 2. First contact arms 31 of the other row of first terminals 3 and second contact arms 41 of the other two second terminals 4 are aligned in a line in the longitudinal direction Y and are respectively embedded in the plurality of mounting slots 21 on the other side of the inner housing 2.

As shown in FIGS. 7 to 12, in the illustrated embodiment, a top portion of the inner housing 2 protrudes from a top opening of the outer housing 1 to a predetermined height, and the insertion slot 20 is formed in a top surface of the inner housing 2 and extends in the height direction Z of the outer housing 1 to a predetermined depth.

As shown in FIGS. 7 to 12, in the illustrated embodiment, the inner housing 2 is supported in a suspended manner in an inner cavity of the outer housing 1 by means of the first elastic structures 33 of the two rows of first terminals 3 and the second elastic structures 43 of the two pairs of second terminals 4, so that the inner housing 2 is floatable in the transverse direction X, in the longitudinal direction Y and in the height direction Z perpendicular to the transverse direction X and longitudinal direction Y relative to the outer housing 1.

As shown in FIGS. 7 to 12, in the illustrated embodiment, a bottom surface of the inner housing 2 is higher than a bottom surface of the outer housing 1 to allow the inner housing to float in the height direction relative to the outer housing.

As shown in FIGS. 7 to 12, in the illustrated embodiment, the outer housing 1 is an overmolded part formed by overmolding on the two rows of first terminals 3 and the two pairs of second terminals 4, so that the outer housing 1, the two rows of first terminals 3 and the two pairs of second terminals 4 form an integral part.

As shown in FIGS. 7 to 12, in an exemplary embodiment of the present invention, the above first terminal 3 is a signal terminal, and the above second terminal 4 is a power terminal.

As shown in FIGS. 7 to 12, in another exemplary embodiment of the present invention, there is provided a connector assembly. The connector includes: the illustrative connector and a mating connector. The mating connector is configured to mate with the connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an outer housing having two side walls opposite each other in a transverse direction thereof and two end walls opposite each other in a longitudinal direction thereof;
an inner housing arranged in the outer housing and having a plurality of mounting slots formed on both sides of the inner housing in the transverse direction;
two rows of first terminals respectively arranged on two sides of the inner housing in the transverse direction;
two pairs of second terminals respectively arranged at two ends of the inner housing in the longitudinal direction, each first terminal includes a first fixing portion fixed into a side wall of the outer housing, a first contact arm embedded in a mounting slot of the inner housing, and a first elastic structure connected between the first fixing portion and the first contact arm;
the two pairs of second terminals each include a second fixing portion fixed into an end wall of the outer housing, a second contact arm embedded in the mounting slot of the inner housing, and a second elastic structure connected between the second fixing portion and the second contact arm; and
the first elastic structure is elastically deformable in the transverse direction, and the second elastic structure is elastically deformable in the longitudinal direction, the inner housing is floatable in the transverse direction and in the longitudinal direction relative to the outer housing, the second elastic structure is located between adjacent end walls of the outer housing and the inner housing, and extends in a height direction of the outer housing and in an inclination direction at a predetermined angle relative to the longitudinal direction, the second elastic structure is elastically deformable in the longitudinal direction and in the transverse direction.

2. The connector of claim 1, wherein the first elastic structure is located between adjacent side walls of the outer housing and the inner housing and extends in the transverse direction and in the height direction of the outer housing, the first elastic structure is elastically deformable in the transverse direction.

3. The connector of claim 1, wherein the second elastic structure is bent into one of a U shape, an N shape or an Ω shape.

4. The connector of claim 3, wherein the two ends of the second elastic structure are connected to the second fixing portion and the second contact arm.

5. The connector of claim 1, wherein the first terminal further includes a first solder pin connected to a lower end of the first fixing portion.

6. The connector of claim 5, wherein a second terminal further includes a second solder pin connected to a lower end of the second fixing portion.

7. The connector of claim 6, wherein a plurality of first solder pins of one of the two rows of first terminals and a plurality of second solder pins of a first pair of two pairs of second terminals are aligned in a line in the longitudinal direction.

8. The connector of claim 7, wherein the plurality of first solder pins of a second row of the two rows of first terminals and the plurality of second solder pins of a second pair of the two pairs of second terminals are aligned in the line in the longitudinal direction.

9. The connector of claim 8, wherein the second fixing portion is plate-shaped and perpendicular to the transverse direction.

10. The connector of claim 9, wherein the second solder pin is plate-shaped and perpendicular to the height direction, the second fixing portion and the second solder pin of a second terminal of two pairs of second terminals form an L-shaped plate.

11. The connector of claim 8, wherein a bottom surface of the first solder pin and a bottom surface of the second solder pin are located in one horizontal plane that is perpendicular to the height direction, to enable the first solder pin and the second solder pin to be soldered to a circuit board in a surface-mount manner.

12. The connector of claim 1, wherein an insertion slot extending in the longitudinal direction is formed in the inner housing, the plurality of mounting slots are in communication with the insertion slot, the first contact arm is provided with a protruding first contact portion, and the second contact arm is provided with a protruding second contact portion.

13. The connector of claim 12, wherein each first contact portion of the two rows of first terminals and each second contact portion of the two pairs of second terminals, respectively protrude from the mounting slot on the two sides of the inner housing into the insertion slot to make electrical contact with a pair of sides of a mating connector inserted into the insertion slot.

14. The connector of claim 13, wherein first contact arms of one of the two rows of first terminals and a first pair of second contact arms of the two pairs of second terminals are aligned in a line in the longitudinal direction and are respectively embedded in the plurality of mounting slots on one side of the inner housing and the first contact arms of a second row of first terminals and a second pair of second contact arms of the two pairs of second terminals are aligned in the line in the longitudinal direction and are respectively embedded in the plurality of mounting slots on a second side of the inner housing.

15. The connector of claim 13, wherein a top portion of an inner housing protrudes from a top opening of the outer housing to a predetermined height, and the insertion slot is formed in a top surface of the inner housing and extends in the height direction of the outer housing to a predetermined depth.

16. The connector of claim 1, wherein the inner housing is supported in a suspended manner in an inner cavity of the outer housing by means of a plurality of first elastic structures of the two rows of first terminals and a plurality of second elastic structures of the two pairs of second terminals.

17. The connector of claim 16, wherein a bottom surface of the inner housing is higher than a bottom surface of the outer housing.

18. The connector of claim 1, wherein the outer housing is an overmolded part formed by overmolding on the two rows of first terminals and the two pairs of second terminals, the outer housing, the two rows of first terminals and two pairs of second terminals form an integral part.

19. The connector of claim 1, wherein the first terminal is a signal terminal, and a second terminal is a power terminal.

20. A connector assembly, comprising:
a connector having:
an outer housing having two side walls opposite each other in a transverse direction thereof and two end walls opposite each other in a longitudinal direction thereof;
an inner housing arranged in the outer housing and having a plurality of mounting slots formed on both sides of the inner housing in the transverse direction;
two rows of first terminals respectively arranged on two sides of the inner housing in the transverse direction;
two pairs of second terminals respectively arranged at two ends of the inner housing in the longitudinal direction, each first terminal includes a first fixing portion fixed into a side wall of the outer housing, a first contact arm embedded in a mounting slot of the inner housing, and a first elastic structure connected between the first fixing portion and the first contact arm;
the two pairs of second terminals each include a second fixing portion fixed into an end wall of the outer housing, a second contact arm embedded in the mounting slot of the inner housing, and a second elastic structure connected between the second fixing portion and the second contact arm;
the first elastic structure is elastically deformable in the transverse direction, and the second elastic structure is elastically deformable in the longitudinal direction, the inner housing is floatable in the transverse direction and in the longitudinal direction relative to the outer housing, the second elastic structure is located between adjacent end walls of the outer housing and the inner housing, and extends in a height direction of the outer housing and in an inclination direction at a predetermined angle relative to the longitudinal direction, the second elastic structure is elastically deformable in the longitudinal direction and in the transverse direction; and
a mating connector configured to mate with the connector.
